(19) United States
(12) Patent Application Publication
(10) Pub. No.: US 2009/0265343 A1
(43) Pub. Date: Oct. 22, 2009

(54) SYSTEMS AND METHODS FOR CREATIVE WORKS REGISTRATION AND OWNERSHIP DETERMINATIONS

(75) Inventors: Graham R. McFarland, Parker, TX (US); Kevin E. McFarland, Austin, TX (US)

Correspondence Address: PATTON BOGGS LLP, 1801 CALFORNIA STREET, SUITE 4900, DENVER, CO, 80202, US

(73) Assignee: Express Digital Graphics, Inc., Austin, TX (US)

(21) Appl. No.: 12/426,068

(22) Filed: Apr. 17, 2009

Related U.S. Application Data
(60) Provisional application No. 61/045,882, filed on Apr. 17, 2008.

(51) Int. Cl. G06F 7/06; G06F 17/30

(52) U.S. Cl. 707/5; 707/104.1; 707/E17.019; 707/E17.014; 707/6

(57) ABSTRACT

Systems and methods for creative work registration are described. In one aspect, a processor may perform various steps. An upload of a creative work may be received at the processor. The processor then may create a digital fingerprint for the creative work. The processor then may associate the digital fingerprint with the creative work and associate ownership information with the digital fingerprint and the creative work. The associated ownership information, digital fingerprint, and the creative work may be stored in a database.

### BACKGROUND

As photography continues to move towards delivery of the digital file, issues such as ownership of a photo or image become more important. Very few professional photographers regularly register their work with the Copyright Office, and these professional photographers generally are the only photographers that have a realistic chance of enforcing their copyright in court. Determination of ownership is important to photographers as it provides the basis on which to generate revenue. Professional Photographers of America, Inc. (PPA) alone gets thousands of calls annually to their customer service center looking for a copyright owner of a photograph. Currently, the Copyright Office provides that photographer organizations can independently develop their own criteria for a reasonable search. The PPA has recently denounced this method as “too flexible”, making it difficult for non-professional users to have a reasonable idea of when a “good faith” and “diligent” search has been completed. Here are two examples given by the PPA to describe the problem.

Scenario A: A wedding photographer provided images to a client and properly marked the work. Later, the wedding client placed the images in an album using adhesives that made viewing the copyright information impossible. A few years pass, and the memory of the client becomes cloudy as to the exact identity of their photographer. At that point, the child of the client decides to distribute copies of the wedding images to the bride's and groom's descendants. Finding it impossible to identify the photographer from the prints themselves or from his parents, he proceeds to distribute copies of the wedding images without permission of the copyright owner.

Scenario B: A photographer's work is used in an advertising campaign. While the photographer leaves identifying metadata in the digital file and marks any prints that leave her studio, the standard in the advertising world is to not provide a credit line when an agency publishes the work. A subsequent user sees the image and wants to use it. Finding no credit line identifying the photographer, this subsequent user contacts the company whose product was advertised and perhaps even the ad agency, but no one who currently works there can recall who created the image or they simply refuse to take the time to talk to him. The subsequent user then posts the image on his personal page on a website without the copyright owner's permission where the image is copied thousands of times over.

In general, and even though the photographers in scenarios A and B took reasonable steps to identify themselves or make themselves known to all subsequent users, subsequent users were not able to identify the owners of copyright in the images. This is problematic to authors of original works in general, such as photographers and copyright owners, as these entities would like to control distribution of their intellectual property assets.

### SUMMARY

Systems and methods for creative work registration are described. In one aspect, a processor receives an upload of a creative work. Responsive to receipt of the creative work, the processor may then create a digital fingerprint for the creative work. The processor may then associate the digital fingerprint with the creative work and associate ownership information with the digital fingerprint and the creative work. The associated ownership information, digital fingerprint, and the creative work may be stored in a database for subsequent querying and verification of the owner of the copyright in the creative work.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for creative works registration and ownership determinations in a networked computing environment, according to one embodiment.

FIG. 2 shows an exemplary creative works registry server for registration and ownership determinations in a networked computing environment, according to one embodiment.

FIG. 3 shows an exemplary procedure for a creative works owner to interface with the system of FIG. 1 to register creative works for subsequent consumer/end-user ownership determinations, according to one embodiment.

FIG. 4 shows an exemplary procedure for a creative works consumer to interface with the system of FIG. 1 to determine ownership of a particular creative work, according to one embodiment.

### DETAILED DESCRIPTION

### Overview

Establishing a registry would provide a “good faith” and “reasonably diligent” search for determining ownership as required by the Copyright Office. A need exists for professional photographers, fulfillment partners (e.g., Walgreens, Wal-Mart, Kinko's, Shutterfly), and consumers to establish a clearinghouse where photos can be registered (a “registry”) by the owner and documented for copyright purposes. Such a registry would provide the end-user with a clear process and “best practice” within the creative works industry to determine ownership. Without such a service, an end-user can use any orphan work for any commercial purpose; and it is up to the owner to catch the abuser. However, if the end-user can show they performed a “reasonable” and “diligent” search for the owner, they are only required to pay “reasonable” compensation for the use of the infringed work. If the user cannot identify the owner of a photo, they can use it for any reason; and if the owner comes forward in the future, the end-user is only responsible to pay what they would have had to pay in the first place. The law does not provide for punitive damages for the infringement. That is why it is important to protect the photographer's works before an infringement occurs, making it easy for end-users to identify ownership.

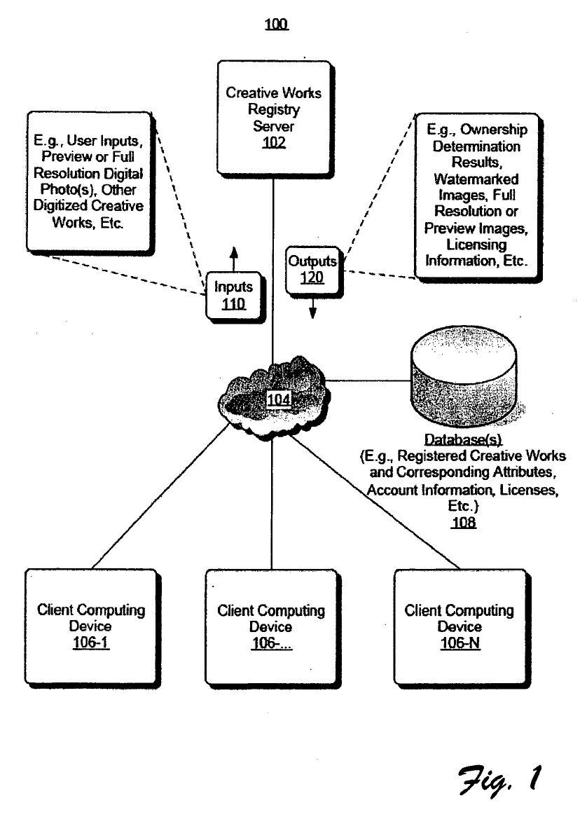

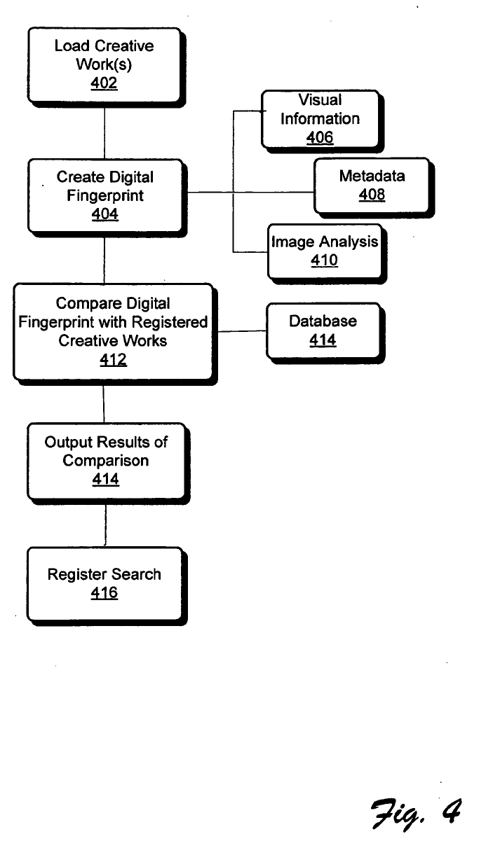

In one implementation, for example, systems and methods for creative works registration and ownership determinations allow professional and other types of photographers to create an account to register their creative works (e.g., photos, digitized art, etc.) with a Registry Service. In one implementation, registration is accomplished by uploading a small preview file (and/or a full resolution file) of the photo along with a unique digital fingerprint. The Registry Service generates the uploaded photo's digital fingerprint by analyzing the photo to determine objectively unique aspects of the photo. In one implementation, for example, the Registry Service generates the digital fingerprint by combining visual appearance, metadata, and image classifiers. Once a photo is registered, and responsive to a user or other automated inquiry (e.g., responsive to a predetermined detected event), the Registry Service evaluates the digital fingerprint to compare the registered photo to another designated photo in the registry (or other location) to determine ownership. Examples of a system to accomplish this are shown, for example, with respect to FIGS. 1 through 4 and corresponding portions of the Appendix. In one implementation, the Registry Service comprises a web database accessible 24/7 anywhere in the world.

### An Exemplary System

We now describe systems, methods, and apparatus for creative works registration and ownership determinations with respect to FIGS. 1 through 4 and the Appendix. Although not required, the systems, methods, and apparatus are described in the general context of computer program instructions executed by one or more computing devices. Computing devices typically include one or more processors coupled to data storage for computer program modules and data. Such program modules generally include computer program instructions such as routines, programs, objects, components, etc., for execution by the at least one processor to perform particular tasks, utilize data, data structures, and/or implement particular abstract data types. While the systems, methods, and apparatus are described in the foregoing context, acts and operations described hereinafter may also be implemented in hardware.

FIG. 1 shows an exemplary system 100 for creative works registration and ownership determinations, according to one embodiment. In this exemplary implementation, system 100 includes creative works registry server 102 operatively coupled over network 104 to one or more client computing devices 106 (e.g., 106-1 through 106-N) and one or more databases 108. Creative works registry server 102 represents, for example, any one or more of a server, a general-purpose computing device such as a server, a personal computer (PC), a laptop, and/or so on. Networks 104 represent, for example, any combination of the Internet, local area network(s) such as an intranet, wide area network(s), and/or so on. Such networking environments are commonplace in offices, enterprise-wide computer networks, etc. Client computing devices 106, which may include at least one processor, represent a set of arbitrary computing devices executing application(s) that respectively send data inputs 110 to creative works registry server 102 and/or receive data outputs 120 from creative works registry server 102. Such computing devices include, for example, one or more of desktop computers, laptops, mobile computing devices (e.g., PDAs), server computers, and/or so on. In this implementation, the input data comprises, for example, digital photos, images, and/or so on, for registering with system 100. In one implementation, the data outputs include, for example, image ownership analysis results, modified images, and/or so on.

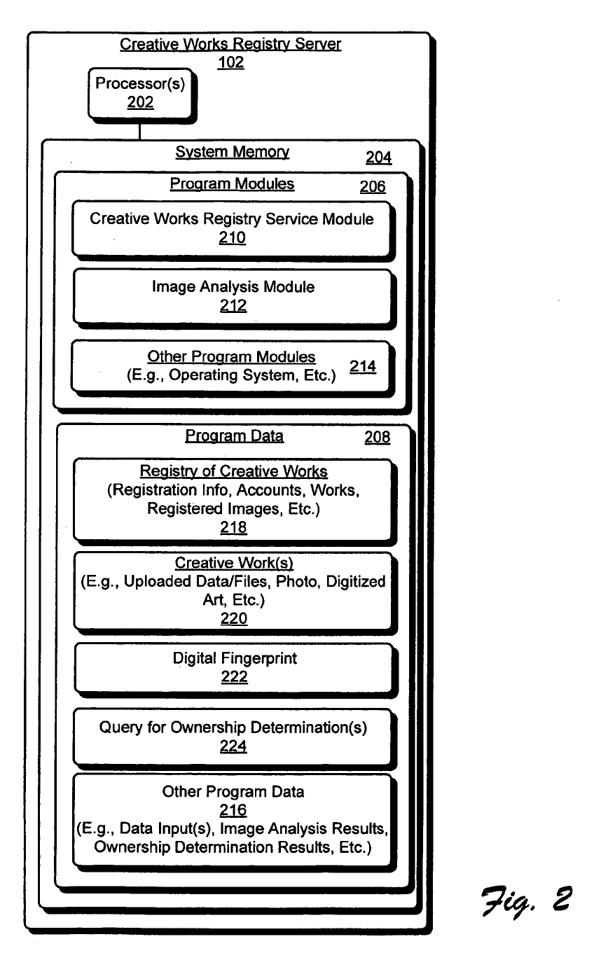

FIG. 2 shows an exemplary creative works registry server 102 for creative works registration and ownership determinations, according to one embodiment. In the description, the leftmost numeral of a reference number indicates the figure where the component was first introduced. For example, a reference to reference number 102 has a “1” as the leftmost number of the reference number, indicating that component 102 (i.e., creative works server 102) was first introduced in FIG. 1.

In this exemplary implementation, server 102 includes at least one processor 202 coupled to a system memory 204. System memory 204 comprises computer program modules 206 and program data 208. In this implementation, program modules 206 include creative works registry service module 210, image analysis module 212, and other program modules 214 such as an operating system, device drivers, etc. Each program module 210 through 214 includes a respective set of computer-program instructions executable by processor(s) 202. This is one example of a set of program modules, and other numbers and arrangements of program modules are contemplated as a function of the particular arbitrary design and/or architecture of server 102 and/or system 100 (FIG. 1). Additionally, although shown on a single computing device 102, the operations associated with respective computer program instructions in the program modules 206 could be distributed across multiple computing devices.

In this implementation, creative registry works service module 210 receives a set of data inputs 110 (FIG. 1), which is also shown as a respective portion of other program data 216. These data inputs allow professional and other types of photographers and copyright owners to create an account 218 to register their creative works (e.g., photos, digitized art, etc.) 220 with server 102. Although shown on server 102, such works 220 may also be stored independent of server 102, for example, in a remote database, etc. In one implementation, server 102 receives creative works such as a small preview file (and/or a full resolution file) of the photo along with a unique digital fingerprint. The Registry Service 210 generates the uploaded photo's digital fingerprint 222 by analyzing the uploaded image (e.g., using logic of image analysis module 212) to determine objectively unique aspects of the image. In one implementation, for example, the Registry Service 210 generates the digital fingerprint 222 by combining visual appearance, metadata, and image classifiers extracted and/or generated from information in the image. Once a creative work 218 is registered, and responsive to a user or other automated inquiry (e.g., responsive to a predetermined detected event) such as receipt of query 224, the Registry Service 210 evaluates the digital fingerprint 222 to compare the registered image to another designated photo in the registry 220 (or other location) to determine ownership results (shown as a respective portion of other program data 216). Server 102 returns ownership determination results to the querying entity for presentation and creative work ownership determination. In one implementation, the resulting data outputs include, for example, image ownership analysis results, modified images, etc.

### An Exemplary Procedure

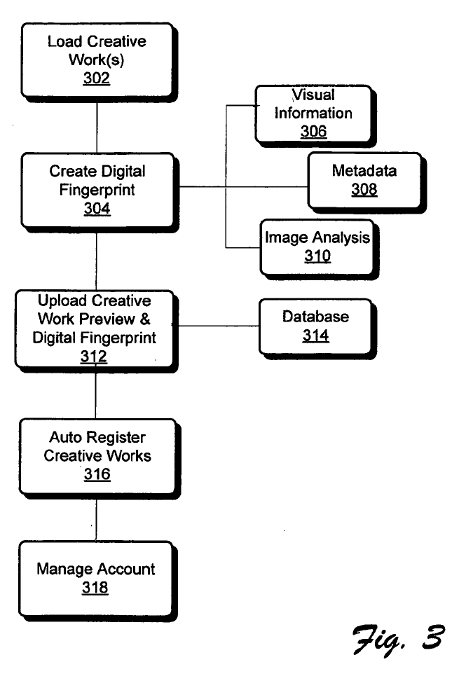

FIG. 3 shows an exemplary procedure for a creative works owner such as a professional photographer (e.g., commercial, portrait/social, etc.) to interface with the creative works registry server of FIGS. 1 and 2 to register creative works for subsequent ownership determinations, according to one implementation. For purposes of exemplary description and illustration, the operations of the procedure are described with respect to corresponding components of FIG. 1. In the description, the leftmost numeral of a reference number indicates the figure where the component was first introduced.

Referring to FIG. 3, at 302 the end-user or an automated process provides/loads one or more digital images or other creative works (e.g., respective data inputs 110) to creative works registry server 102. In one implementation, these data inputs are associated with a particular account/registry of a predetermined entity (e.g., end-user, account holder, etc.). For example, a photographer may interface with the creative works registry server 102 to create a registry account that includes, for example, contact and business information (e.g., registrant's name, studio name, address, phone, etc.). In one implementation, for example, the photographer utilizing a software application on a client computing device 106 selects a catalog or individual digital images and selects an available option to auto register (please see item 310) the selected images with the creative works registry server 102. At 304, and responsive to receiving the data inputs 110 (e.g., digital images), the server creates a digital fingerprint for each received data input. In one implementation, server 102 also generates a small preview or thumbnail (a sub-sampled version of an original data input) of each digital image received. As shown in 304, the digital fingerprint for a particular data input may be comprised of data based on one or more of visual, metadata, and image analysis aspects (e.g., tonal characteristics, RGB values, etc.) of the data input. Items 306 and 308 represent association and registration of the respective digital fingerprints and any corresponding digital image previews and/or original/normal resolution digital images into corresponding accounts in the Registry, which is shown as being stored on a database 308. Such registration includes storage/archival of one or more of the previews and/or original/normal resolution digital images and corresponding attributes (including respective digital fingerprints) into the database. At this point, the digital images are now registered; and the end-user can view their collection of registered images or other creative works online, manage their account (312), view search activity associated with their registered creative works, etc.

FIG. 3 shows, for example, a procedure for an end-user to interface with a creative works registry server 102 to determine ownership of one or more creative works, according to one embodiment. Such end-users include, for example, consumers, ad agency, print shop, retail lab, and/or so on. For purposes of exemplary description and illustration, the operations of the procedure are described with respect to corresponding components of FIG. 1. In the description, the leftmost numeral of a reference number indicates the figure where the component was first introduced.

Referring to FIG. 3, at 302, an end-user uploads a creative work into a creative works ownership determination service provided by creative works registry server 102. In this example, the creative work is a digital image; and the end-user desires to determine ownership of the digital image (the “query image”), for example, to utilize the image in an advertisement or other manner. At 304, creative works registry server 102 creates a digital fingerprint for the query image using substantially the same procedures utilized to generate respective digital fingerprints for digital images in the registry created and maintained by the creative works registry server 102. Exemplary operations to generate a digital fingerprint are described above with respect to reference number 304 of FIG. 3. At 306, creative works registry server 102 compares the digital fingerprint of the query image to respective digital fingerprints in the registry/database. At 308, creative works registry server 102 outputs and/or displays the results of the digital fingerprint comparisons.

For example, and with respect to 308 of FIG. 3, if there is a perfect or near-perfect match between the query image digital fingerprint (“query fingerprint”) and a registered image digital fingerprint (“registered fingerprint”), creative works registry server 102 displays a preview of the corresponding matched registered creative work for viewing by the end-user, along with copyright and other information. In one implementation, a near-perfect or substantial match is determined in view of predefined and configurable similarity thresholds. In one implementation, such other information includes, for example, owner name, contact information, licensing information (e.g., Creative Commons licensing information, etc.), and/or so on. In one implementation, if there is no objective and automatically determined match between the query fingerprint and any registered fingerprint, then previews of any similar, but less than substantially matching, registered photos are displayed next to the query image along with percentage similarity indications (e.g., 50% similar) associated with respective ones of the similar registered images. This allows the end-user to browse any semi-matches of registered images to the query image to visually determine if a match exists. In one implementation, this latter feature allows the end-user to identify any derivative photos corresponding to the query image, where any such derivative photos may have been cropped, edited, or retouched.

At 310, the end-user has the option to record characteristics of the search and corresponding results to locate any owner of the query image. In one implementation, creative works registry server 102 stores such records for access by owners of matched, substantially matched, partially matched, and/or unmatched registry photos (i.e., creative works stored in a database maintained by server 102). The system may facilitate communication between the end-user and the owner of a registered image.

In one implementation, for example, an end-user (a consumer of creative work ownership determination services of creative works registry server 102) associated with a particular client computing device 106 (FIG. 1) visits a registry website published by the creative works registry server 102 to download an application (shown as a respective output data 112). In this implementation, the downloaded application may execute at the client computing device 106 to perform the operations described above with respect to FIG. 3 to determine whether a query image or creative work matches any images or creative works registered with creative works registry server 102. To this end, for example, the downloaded application executing on the client computing device communicates with the creative works registry server 102 to provide the corresponding logic and results to the end-user.

In another implementation, a computer software developer implements an application programming interface (API) exposed by a library (e.g., a dynamic link library) to provide the above-described functionality to executing computer program applications and end-users. In one implementation, the API communicates with the library, which in turn correspondingly communicates with the service exposed by creative works registry server 102.

### Alternate Implementations

Licensing Enablement and Management: In one implementation, creative works registry server 102 provides means (e.g., user interface control(s)) for an end-user/consumer to indicate interest in licensing a particular registered creative work (e.g., a digital image) from an owner of the creative work. Responsive to detecting such interest, and in one embodiment, creative works registry server 102 contacts the owner to indicate such interest by the end-user. Responsive to determining such interest, the owner of the creative work may interface with creative works registry server 102 to create a license for the creative work of interest. In one implementation, creative works registry server 102 provides means such as one or more user interface controls in a dialog box to allow the owner to define a license for the creative work. In one implementation, creative works registry server 102 provides such license definition or selection by utilizing an API exposed by a licensing service. Licensing services such as Creative Commons™ are known. Creative works registry server 102 utilizes the API to provide licensing specifics such as name and contact information of the Licensor, duration of the license, and/or so on.

Creative works registry server 102 generates and associates a substantially unique key specific to the license for storing with the creative work in the registry. The unique key may be stored as a subset of the digital fingerprint and identify the individual license associated with the image. An image can have multiple licenses applied, and the unique key identifies the appropriate license on the website as part of the search function. The unique key may be embedded in the digital file for identification. The unique key, the license, and any other associated information may include respective attributes of the registered digital image. Creative works registry server 102 provides the license along with a normal resolution copy of the creative work to the requesting end-user.

In one implementation, when a consumer or owner of a creative work registered with creative works registry server 102 views the creative work, creative works registry server 102 also presents the viewer with any corresponding licensing information. A registered creative work may be associated with one or more licensing arrangements.

### Conclusion

Although the above sections describe creative works registration and ownership determinations in language specific to structural features and/or methodological operations or actions, the implementations defined are not necessarily limited to the specific features or actions described. Rather, the specific features and operations for creative works registration and ownership determinations are disclosed as exemplary forms of implementing the claimed subject matter.

1. A system for creative work registration, the system comprising:
a processor;
a memory operatively coupled to the processor, the memory comprising computer program instructions executable by the processor for performing steps of:
receiving an upload of a creative work;
creating a digital fingerprint for the creative work;
associating the digital fingerprint with the creative work;
associating ownership information with the digital fingerprint and the creative work;
storing the associated ownership information, digital fingerprint, and the creative work in a database; and
presenting the ownership information to an end-user responsive to receiving a query.

2. The system of claim 1 wherein the digital fingerprint comprises visual data, metadata, and image analysis information.

3. The system of claim 1 wherein the creative work comprises digital images.

4. The system of claim 1, further comprising a step of receiving registry account information from a user, and wherein the ownership information is derived from the registry account information.

5. The system of claim 4, further comprising a step of allowing a user to manage the registry account information.

6. The system of claim 1, further comprising a step of generating a sub-sampled version of the creative work.

7. The system of claim 1, further comprising a step of associating the sub-sampled version of the creative work with the associated ownership information, digital fingerprint, and the creative work.

8. A tangible computer-readable storage medium comprising computer program instructions executable by a processor, the computer program instructions performing operations for creative work ownership determinations when executed by the processor, the operations comprising:
receiving an upload of a query work;
creating a query fingerprint for the query work;
comparing the query fingerprint with registered fingerprints for creative works, wherein the registered fingerprints are stored in a database;
determining creative works with registered fingerprints that substantially match the query fingerprint based upon the comparing step; and
outputting, for viewing by an end-user, the results of the determining step and registry information associated with the results of the determining step.

9. The tangible computer-readable storage medium of claim 8, further comprising an operation of providing a preview of the results of the determining step.

10. The tangible computer-readable storage medium of claim 9 wherein the results of the determining step are provided if the registered fingerprint meets predetermined criteria in comparison to the query fingerprint.

11. The tangible computer-readable storage medium of claim 8, further comprising an operation of providing registry information for creative works with similar registered fingerprints if there is no substantial match.

12. The tangible computer-readable storage medium of claim 8, further comprising an operation of identifying derivative creative works related to the query work.

13. The tangible computer-readable storage medium of claim 8, further comprising storing a record of the results.

14. The tangible computer-readable storage medium of claim 8 wherein the user connects to the processor over a network.

15. The tangible computer-readable storage medium of claim 8 wherein the registry information comprises owner name, contact information, and available licensing information.

16. A method implemented by a computing device for licensing and managing creative works, the method comprising steps of:
providing access to a database of creative works, wherein the database further comprises digital signatures associated with each creative work;
receiving a query regarding ownership of the creative works in the database; and
providing matching creative works that satisfy the query.

17. The method of claim 16, further comprising steps of:
receiving a selection of at least one of the matching creative works;
creating a license for each of the at least one of the matching creative works;
creating a unique key for each of the licenses; and
associating the unique key with each of the licenses and the matching creative works.

18. The method of claim 17, further comprising a step of storing the unique key in a database.

19. The method of claim 18, further comprising a step of storing information regarding the unique key with the matching creative work.

20. The method of claim 16, further comprising a step of providing the licenses and the matching creative works to a user initiating the query.
